(19) United States
(12) Patent Application Publication
(10) Pub. No.: US 2013/0021211 A1
(43) Pub. Date: Jan. 24, 2013

(54) ANTENNA AND MOBILE COMMUNICATION APPARATUS

(71) Applicants: Kunihiro KOMAKI, Kyoto-fu (JP); Tsuyoshi MUKAI, Kyoto-fu (JP); Masayuki ATOKAWA, Kyoto-fu (JP)

(72) Inventors: Kunihiro KOMAKI, Kyoto-fu (JP); Tsuyoshi MUKAI, Kyoto-fu (JP); Masayuki ATOKAWA, Kyoto-fu (JP)

(73) Assignee: MURATA MANUFACTURING CO., LTD., Kyoto-fu (JP)

(21) Appl. No.: 13/619,316

(22) Filed: Sep. 14, 2012

Related U.S. Application Data
(63) Continuation of application No. PCT/JP2011/069690, filed on Aug. 31, 2011.

(30) Foreign Application Priority Data
Sep. 8, 2010 (JP) 2010-200997

(51) Int. Cl. H01Q 1/38

(52) U.S. Cl. 343/700 MS

(57) ABSTRACT

This disclosure provides an antenna and mobile communication apparatus including an antenna, where the antenna includes a base member and a radiation electrode provided on the base member. The radiation electrode includes a feeding portion and an open end, and at least one phase control element provided between the feeding portion and the open end. With the length of the lengthwise direction of the base member taken as L, and with the wavelength on the base member of the usable frequency range taken as λ, L<λ/5. Through this configuration, it is possible to configure an antenna that can be disposed within a limited amount of space and that can obtain high radiation efficiency, and a mobile communication apparatus that includes the antenna and thus has high communication capabilities.

### CROSS REFERENCE TO RELATED APPLICATIONS

The present application claims priority to International Application No. PCT/JP2011/069690 filed on Aug. 31, 2011, and to Japanese Patent Application No. 2010-200997 filed on Sep. 8, 2010, the entire contents of each of these applications being incorporated herein by reference in their entirety.

### TECHNICAL FIELD

The technical field relates to antennas used in mobile communication, and to mobile communication apparatuses provided with such antennas.

### BACKGROUND

Japanese Unexamined Patent Application Publication No. 2004-128605 (Patent Document 1), for example, discloses an antenna provided within a casing of a mobile communication apparatus and mounted on a mounting board. FIG. 1 is a perspective view illustrating the structure of the antenna disclosed in Patent Document 1. As shown in FIG. 1, one end 3A of a radiation electrode 3 is connected to a conductive portion formed on the front surface or rear surface of a board 2, and the radiation electrode 3 is formed so as to follow a loop-shaped path that starts from the one end (a board-connected end) 3A connected to the conductive portion, encloses a board edge 2T while extending away from the conductive portion, and follows the board surface, with a gap, on the opposite side to the side on which the conductive portion is located. Another end 3B of the radiation electrode 3 is formed so as to be an open end disposed with a distance between the other end 3B and the conductive portion.

Generally, reducing the height of an antenna relative to its mounting board will cause the antenna characteristics to degrade; however, the electric length of the radiation electrode 3 is increased by forming the radiation electrode 3 so as to be bent around an edge of the board 2 from one of the board surfaces to the other board surface, as shown in FIG. 1. This makes it possible to miniaturize and slim down the radiation electrode 3 while providing a set resonance frequency. Furthermore, because the size of the space enclosed by the board 2 and the radiation electrode 3 can be increased, the gain can be improved and the bandwidth can be increased.

### SUMMARY

The present disclosure provides an antenna that can be provided within a limited amount of space and having a high radiation efficiency, and a mobile communication apparatus provided with such an antenna and that has high communication capabilities.

An antenna according to the present disclosure includes a base member and a radiation electrode provided on the base member. With the length of the lengthwise direction of the base member taken as L, and with the wavelength on the base member at the lowest frequency in the usable frequency range taken as λ, L<λ/5. The radiation electrode includes a feeding portion and an open end, and a phase control element provided between the feeding portion and the open end.

A mobile communication apparatus according to the present disclosure includes an antenna having a radiation electrode on a base member, a board to which the antenna is mounted, and a casing that contains the board. With the length of the lengthwise direction of the base member taken as L, and with the wavelength on the base member of the usable frequency range taken as λ, L<λ/5. The radiation electrode of the antenna includes a feeding portion and an open end, and a phase control element provided between the feeding portion and the open end.

In a more specific embodiment, the base member may be a molded member formed of a dielectric material.

In another more specific embodiment, the base member may be a composite molded member formed of a dielectric ceramic material and a resinous material.

In yet another more specific embodiment, the radiation electrode need not be configured only of a feeding radiation electrode, and may be configured of a feeding radiation electrode and a parasitic radiation electrode.

In still another more specific embodiment, the base member may be parallelepiped-shaped.

In another more specific embodiment, the feeding portion may include a feeding terminal provided on one side of the base member, and the radiation electrode is provided on plural sides of the base member not including the one side.

In another more specific embodiment, at least one additional phase control element may be provided series partway along the radiation electrode.

### BRIEF DESCRIPTION OF DRAWINGS

FIG. 1 is a perspective view illustrating the structure of an antenna disclosed in Patent Document 1.

FIG. 2A is a perspective view illustrating a mounting board on which an antenna according to a first exemplary embodiment is mounted. FIG. 2B is a schematic cross-sectional view illustrating a mobile communication apparatus in which the mounting board is disposed within casing bodies.

FIG. 3 is a perspective view illustrating the antenna mounted to the mounting board.

FIG. 4 illustrates a result of examining a change in 1/Qr when a phase amount has been changed by a phase control element upon a radiation electrode without changing the shape of the radiation electrode.

FIG. 5 is a perspective view illustrating an antenna that is equivalent to, and has almost the same characteristics as the antenna shown in FIG. 3.

FIG. 6 is a perspective view illustrating an antenna according to a second exemplary embodiment mounted to the mounting board.

FIG. 7 is a perspective view illustrating an antenna according to a third exemplary embodiment mounted to the mounting board.

### DETAILED DESCRIPTION

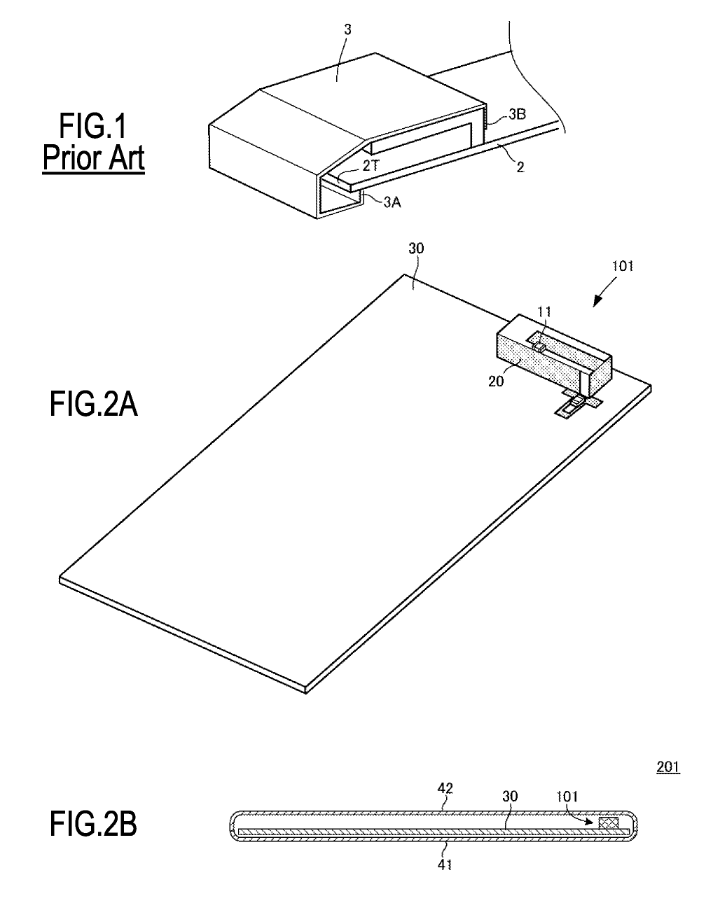

As shown in FIG. 1, disposing a radiation electrode on both sides of a mounting board makes it possible to increase the size of the electrode as compared to a case where the electrode is disposed only on one side. However, it is necessary to bend the radiation electrode around the end of the mounting board, and it is therefore still necessary to provide a space for disposing the radiation electrode. The inventors realized that because mobile communication apparatuses (e.g., mobile telephone terminals) are becoming thinner in recent years, in the case where the electrode is disposed on both sides of the mounting board, the distance between the mounting board and the radiation electrode reduces. As a result, antenna characteristics can degrade.

This disclosure provides an antenna and mobile communication apparatus that can address the above-described shortcomings. It is to be understood that the embodiments described hereafter are exemplary and that other embodiments of an antenna and mobile communication apparatus according to the present disclosure can include variations from, and/or be applied in ways different from, the embodiments described herein without departing from the scope of the disclosure.

An antenna and mobile communication apparatus according to a first exemplary embodiment will now be described with reference to FIG. 2A through FIG. 5.

FIG. 2A is a perspective view illustrating a mounting board 30 to which an antenna 101 is mounted. FIG. 2B is a schematic cross-sectional view illustrating a mobile communication apparatus 201 in which the mounting board 30 is provided within casing bodies 41 and 42.

The antenna 101 is configured of a rectangular parallelepiped dielectric base member (dielectric block) 20 and a conductor having a predetermined pattern formed on the outside surface thereof. The mounting board is configured having circuitry that implements functions required by a mobile communication apparatus. With the antenna 101 surface-mounted or otherwise provided to the mounting board, a feeding circuit is connected to a feeding terminal electrode of the antenna 101.

As shown in FIG. 2B, it is necessary for the antenna 101 to have a low profile in order to make the mobile communication apparatus 201 thinner.

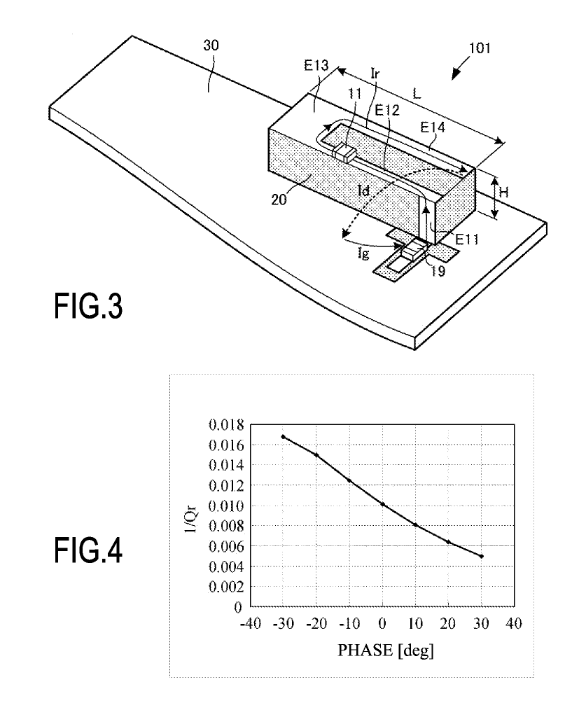

FIG. 3 is a perspective view illustrating the antenna 101 mounted to the mounting board 30. The feeding terminal electrode (not shown) is formed on the bottom surface of the dielectric base member 20 of the antenna 101, i.e., on a surface facing the mounting board 30 or a surface that is to be mounted to the mounting board 30. A conductive pattern E11 that extends from the feeding terminal electrode is formed on the forward surface of the dielectric base member 20. Conductive patterns E12, E13, and E14 that continue from the conductive pattern E11 are formed on the top surface of the dielectric base member 20 (i.e., the surface opposite the surface on which the feeding terminal electrode is provided). A radiation electrode is configured by the conductive patterns E11, E12, E13, and E14. A phase control element 11 is connected in series partway along the conductive pattern E12.

The antenna 101 is provided (e.g., surface-mounted) upon a ground electrode of the mounting board 30, which is an electrode portion of the mounting board 30.

A feeding voltage from the feeding circuit is applied to a feeding end (i.e., the feeding terminal electrode) of the radiation electrode via a feeding line. In the radiation electrode configured of the conductive patterns E11, E12, E13, and E14, a leading end functions as an open end, and a base end functions as the feeding end. A matching element 19 that carries out impedance matching between the feeding circuit and the antenna 101 is mounted between a connection electrode upon the mounting board 30 to which the feeding terminal electrode is connected and the feeding line.

The phase control element 11 controls the position of the maximum electric field point and the position of the maximum current point of the radiation electrode.

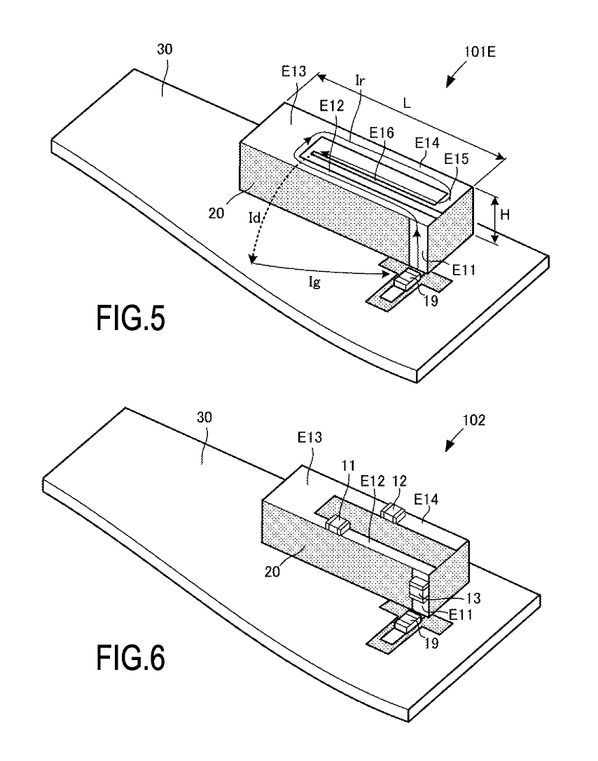

Conventionally, the position of the maximum electric field point and the position of the maximum current point are controlled as a result of changing the length and arrangement of the radiation electrode. Here, FIG. 5 is a perspective view illustrating an antenna 101E that is equivalent to, and has almost the same characteristics as the antenna 101 shown in FIG. 3. With this antenna 101E, the conductive pattern E11 extending from the feeding terminal electrode is formed on the forward surface of the dielectric base member 20, and conductive patterns E12, E13, E14, E15, and E16 that continue from the conductive pattern E11 are formed on the top surface of the dielectric base member 20. A radiation electrode is configured by these conductive patterns E11 through E16.

As indicated by the solid line arrows in FIG. 5, a current Ir flows in the conductive patterns E11 through E16 of the radiation electrode in the antenna 101E from the feeding end toward the open end (and also at times in the opposite direction), and a displacement current Id is produced between the open end, which corresponds to the maximum electric field point of the radiation electrode and the ground electrode of the mounting board. As a result, a current Ig flows in the ground electrode toward the vicinity of a feeding point in the mounting board (and also at times in the opposite direction). This series of current flows is important for utilizing the mounting board as a radiator.

In a small-size antenna, in which the length L of the longest side of the antenna base member 20 and the wavelength λ at the lowest frequency of the base member in the frequency range that is used are in the relationship L<λ/5, it is preferable to use the ground electrode of the mounting board (i.e., the electrode portion of the mounting board—this corresponds to the electrode when the board is thought of as a single flat metal electrode) as a radiator to obtain the necessary antenna radiation characteristics. In other words, if the length L of the longest side of the base member 20 is shorter than λ/4, the necessary radiation electrode length is longer than the length of the side that follows the lengthwise direction of the base member 20, and thus the radiation electrode is bent back along the top surface of the base member. However, because the vertical surface of the base member can also be used, the radiation electrode is bent back at least once along the top surface of the base member if the length L of the longest side of the base member 20 is substantially shorter than λ/5.

For the mounting board to be used effectively as a radiator, the position of the maximum electric field point and the position of the maximum current point in the antenna electrode are of significance. Conventionally, the shape of the electrode, the distance from the mounting board (this corresponds to the antenna height), and so on have been changed, and the electric length has thus been changed by changing the relative positions of the maximum current point and the maximum electric field point, and the electric length itself. Thus a certain electrode size and height from the mounting board have been necessary in order to obtain antenna characteristics.

With the antenna 101 in FIG. 3 as well, as indicated by the solid line arrows in FIG. 3, a current Ir flows in the conductive patterns E11 through E14 of the radiation electrode from the feeding end toward the open end (and at times also in the opposite direction), and a displacement current Id is produced between the open end which corresponds to the maximum electric field point of the radiation electrode and the ground electrode of the mounting board. As a result, a current Ig flows in the ground electrode toward the vicinity of a feeding point in the mounting board (and at times in the opposite direction).

In the case where the position of the maximum electric field point and the position of the maximum current point are no longer optimal due to the miniaturization of the antenna, restrictions on the shape of the electrode, and reducing the profile of the electrode, the phase of the current flowing through the radiation electrode can be controlled by the phase control element 11 on the radiation electrode, and thus the way in which the current flows and the amount of current can be controlled in a loop that takes the vicinity of the feeding point as a starting point.

In this manner, even if the position of the maximum electric field point and the position of the maximum current point change, the position of the maximum electric field point and the position of the maximum current point can be optimized by the phase control element 11. Through this, the manner in which the current flows from the displacement current starting from the maximum electric field point to the current in the mounting board can substantially be prevented from being affected by changes in the shape of the electrode. As a result, the mounting board 30 can be used effectively as a radiator, and the same antenna characteristics as those of the antenna 101E shown in FIG. 5 can be obtained.

In the case where the phase control element 11 is an inductance element, a greater the inductance therein results in a higher shortening effect for the overall length required for the radiation electrode, and the shortening effect is greater near the vicinity of the feeding area, where the current distribution is high. The inductance of the phase control element 11 and the positioning thereof (e.g., mounting position) on the radiation electrode can be determined taking these factors into consideration. However, the phase control element is not limited to an inductance element. The phase control element 11 can be, for example, a circuit configured of an inductor and a capacitor, and is a circuit that, when a signal passes therethrough, can cause the phase of the signal to change as desired.

Meanwhile, the positioning of the antenna 101 on the mounting board 30 (e.g., mounting position) is also an important factor when using the mounting board as a radiating element. It is possible to correct the influence of this positioning using the position of the maximum electric field point and the position of the maximum current point of the antenna. Through this effect, the freedom of the mounting position can be increased.

FIG. 4 illustrates a result of examining a change in 1/Qr when a phase amount has been changed by the phase control element 11 upon the radiation electrode without changing the shape of the radiation electrode. 1/Qr is an index corresponding to the radiation capabilities, and a higher value indicates a higher radiation capability. In this manner, changing the phase value makes it possible to control 1/Qr without changing the radiation electrode.

FIG. 6 is a perspective view illustrating an antenna 102 provided on (e.g., mounted to) the mounting board 30 in accordance with a second exemplary embodiment. As shown in FIG. 6, a feeding terminal electrode (not shown) is provided on the bottom surface of a dielectric base member 20 of the antenna 102, i.e., on a surface facing the mounting board 30 or on a surface to be mounted to the mounting board 30. A conductive pattern E11 extends from the feeding terminal electrode and is provided on a forward surface of the dielectric base member 20. Conductive patterns E12, E13, and E14 that continue from the conductive pattern E11 are formed on a top surface of the dielectric base member 20 (i.e., a surface opposite the surface on which the feeding terminal is provided). A radiation electrode is configured by these conductive patterns E11, E12, E13, and E14.

As shown in FIG. 6, a phase control element 13 is connected in series partway along the conductive pattern E11, a phase control element 11 is connected in series partway along the conductive pattern E12, and a phase control element 12 is connected in series partway along the conductive pattern E14.

In this manner, a plurality of phase control elements may be connected to the radiation electrode. By providing a plurality of phase control elements in a dispersed fashion, a current distribution in the radiation electrode can be made smoother overall, and a phase amount that can be controlled can be increased. In addition, by dividing the phase control elements into elements for rough control and elements for fine control, sensitivity to manufacturing variances can be reduced, which makes it possible to obtain stable characteristics during mass-production.

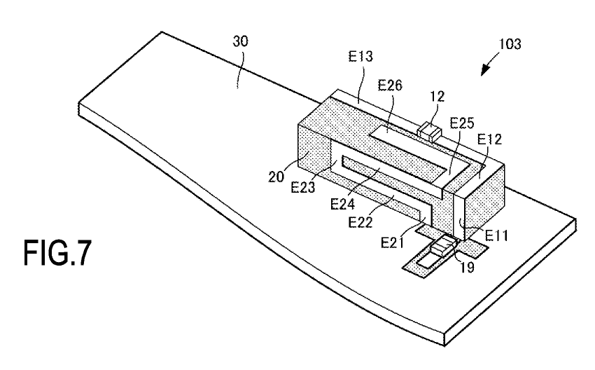

FIG. 7 is a perspective view illustrating an antenna 103 provided on (e.g., mounted to) the mounting board 30 in accordance with a third exemplary embodiment. As shown in FIG. 7, a feeding terminal electrode (not shown) is provided on the bottom surface of a dielectric base member 20 of the antenna 103, i.e., on a surface facing the mounting board 30 or on a surface to be mounted to the mounting board 30. A conductive pattern E11 that extends from the feeding terminal electrode is formed on the forward surface of the dielectric base member 20. Conductive patterns E12 and E13 that continue from the conductive pattern E11 are formed on the top surface of the dielectric base member 20. The radiation electrode is configured by these conductive patterns E11, E12, and E13. As shown in FIG. 7, a phase control element 12 is connected in series partway along the conductive pattern E13.

Antenna 103 includes conductive patterns E21, E22, E23, and E24 that extend from a ground terminal electrode provided (not shown) on the bottom surface of the base member 20 are provided on a forward surface of the dielectric base member 20. Conductive patterns E25 and E26 continue from the conductive pattern E24 and are provided on the top surface of the dielectric base member 20, i.e., on a surface opposite to the surface on which the ground terminal is provided. A parasitic radiation electrode is configured by these conductive patterns E21 through E26.

In the parasitic radiation electrode, the conductive patterns E25 and E26 in particular are parallel with the conductive patterns E12 and E13 of the radiation electrode (the feeding radiation electrode), and thus the two conductive patterns are capacitive-coupled. Wide bandwidth characteristics can be obtained by providing these two radiation electrodes (i.e., the feeding radiation electrode and the parasitic radiation electrode).

In this way, embodiments according to the disclosure can be applied in an antenna configuration having a parasitic radiation electrode.

Aside from a base member constituted by a dielectric ceramic molded member, in other embodiments the base member that forms the radiation electrode may be a composite molded member formed of a dielectric ceramic material and a resinous material.

In embodiments according the present disclosure, the phase on the radiation electrode between the feeding portion and the open end is controlled by the phase control element, and thus phase differences in the current in the maximum current point (mainly the feeding portion) and the maximum electric field point (mainly the radiation electrode open end) can be controlled as desired. Through this control, phase differences in the current can be optimized even with a radiation electrode disposed within a limited amount of space, and thus the radiation efficiency of the antenna can be improved.

That which is claimed is:

1. An antenna provided on a board, the antenna comprising:
a base member; and
a radiation electrode on the base member,
wherein with the length of the lengthwise direction of the base member taken as L, and the wavelength on the base member at the lowest frequency in the usable frequency range taken as λ, L<λ/5, and
the radiation electrode includes a feeding portion and an open end, and a phase control element provided between the feeding portion and the open end.

2. The antenna according to claim 1, wherein the base member is a molded member formed of a dielectric material.

3. The antenna according to claim 1, wherein the base member is a composite molded member formed of a dielectric ceramic material and a resinous material.

4. The antenna according to claim 1, wherein the radiation electrode includes a feeding radiation electrode and a parasitic radiation electrode.

5. The antenna according to claim 2, wherein the radiation electrode includes a feeding radiation electrode and a parasitic radiation electrode.

6. The antenna according to claim 3, wherein the radiation electrode includes a feeding radiation electrode and a parasitic radiation electrode.

7. The antenna according to claim 1, wherein the base member is parallelepiped-shaped.

8. The antenna according to claim 7, wherein the feeding portion comprises a feeding terminal provided on one side of the base member, and the radiation electrode is provided on plural sides of the base member not including the one side.

9. The antenna according to claim 8, wherein at least one additional phase control element is provided series partway along the radiation electrode.

10. A mobile communication apparatus comprising:
an antenna including a radiation electrode on a base member;
a board to which the antenna is mounted; and
a casing that contains the board,
wherein with the length of the lengthwise direction of the base member taken as L and the wavelength on the base member of the usable frequency range taken as λ, L<λ/5, and
the radiation electrode includes a feeding portion and an open end, and a phase control element provided between the feeding portion and the open end.

11. The mobile communication apparatus according to claim 10, wherein the base member is a molded member formed of a dielectric material.

12. The mobile communication apparatus according to claim 10, wherein the base member is a composite molded member formed of a dielectric ceramic material and a resinous material.

13. The mobile communication apparatus according to claim 10, wherein the radiation electrode includes a feeding radiation electrode and a parasitic radiation electrode.

14. The mobile communication apparatus according to claim 11, wherein the radiation electrode includes a feeding radiation electrode and a parasitic radiation electrode.

15. The mobile communication apparatus according to claim 12, wherein the radiation electrode includes a feeding radiation electrode and a parasitic radiation electrode.

16. The mobile communication apparatus according to claim 10, wherein the base member is parallelepiped-shaped.

17. The mobile communication apparatus according to claim 16, wherein the feeding portion comprises a feeding terminal provided on one side of the base member, and the radiation electrode is provided on plural sides of the base member not including the one side.

18. The mobile communication apparatus according to claim 17, wherein at least one additional phase control element is provided series partway along the radiation electrode.
